(19) United States
(12) Patent Application Publication
(10) Pub. No.: US 2023/0130501 A1
(43) Pub. Date: Apr. 27, 2023

(54) SYSTEMS AND METHODS FOR ASYMMETRIC ENCAPSULATION OF BARRIER MATERIALS WITHIN FLEXIBLE FILMS

(71) Applicant: TRANSCONTINENTAL HOLDING CORP., Chicago, IL (US)

(72) Inventors: Carl BUNDY, Chicago, IL (US); Casey Buckner, Chicago, IL (US)

(73) Assignee: TRANSCONTINENTAL HOLDING CORP., Chicago, IL (US)

(21) Appl. No.: 17/969,356

(22) Filed: Oct. 19, 2022

Related U.S. Application Data
(60) Provisional application No. 63/270,438, filed on Oct. 21, 2021.

(51) Int. Cl. B29C 48/08; B32B 7/12; B32B 7/10; B32B 7/08; B32B 27/08; B32B 27/30; B29C 48/00

(52) U.S. Cl. CPC B29C 48/08; B32B 7/12; B32B 7/10; B32B 7/08; B32B 27/08; B32B 27/304; B29C 48/022; B29K 2023/086

(57) ABSTRACT

A film structure includes a barrier layer, a first encapsulation layer, and a second encapsulation layer. The barrier layer is formed of a barrier material having a first side and a second side. The first encapsulation layer is formed of a first encapsulation material and attached to the first side of the barrier layer. The second encapsulation layer is formed of a second encapsulation material and is attached to the second side of the barrier layer. The first encapsulation material is different than the second encapsulation material and the first and second encapsulation layers encapsulate the barrier layer.

### CROSS REFERENCE TO RELATED APPLICATIONS

This application claims the benefit of and priority to U.S. Provisional Patent Application No. 63/270,438, filed Oct. 21, 2021, which is hereby incorporated by reference in its entirety.

### TECHNICAL FIELD

The present disclosure relates generally to flexible packaging films, and more particularly relates to asymmetric encapsulation of barrier materials within flexible films, and related methods for making flexible films.

### BACKGROUND

Flexible packaging films have been used to create barriers that protect perishable goods (e.g., food) during transportation and storage of the perishable goods such as between a producer to a consumer. For example, films may include polymeric materials to prevent the passage of molecules including, for example, gases and water vapor, to protect the perishable goods from the deleterious effects of such gases and water vapors. The films are typically coextruded by feeding layers of polymeric materials into a feed block where they are arranged into a layered configuration prior to extrusion through a die. The films may include a barrier layer formed of specialized barrier materials configured to prevent the migration of molecules such as, for example, oxygen and water vapor, through the film. However, the specialized barrier materials may not form a strong bond to other layer materials that may be necessary to form a complete film. As such, the specialized barrier materials may be completely encapsulated in a single material that forms a strong bond with some layer materials but not with other layer materials. Additionally, some films may require different materials on either side of the barrier layer to accomplish different tasks for different environments. However, because the barrier layer is completely encapsulated in a single material, the differing materials on either side of the barrier layer may not all form a strong bond to the encapsulating material.

For the foregoing reasons, there is a need to provide improved film structures with at least two materials encapsulating the barrier layer to enable the film to have different structures on either side of the film, optimizing the performance of the film for different environments.

### SUMMARY

One aspect of the present disclosure relates to a film structure which includes a barrier layer, a first encapsulation layer, and a second encapsulation layer. The barrier layer is formed of a barrier material having a first side and a second side. The first encapsulation layer is formed of a first encapsulation material and is attached to the first side of the barrier layer. The second encapsulation layer is formed of a second encapsulation material and is attached to the second side of the barrier layer. The first encapsulation material is different than the second encapsulation material and the first and second encapsulation layers encapsulate the barrier layer.

Another aspect of the present disclosure relates to a film structure including a barrier layer, a first encapsulation layer, a second encapsulation layer, a first adhesion layer, and a second adhesion layer. The barrier layer is formed of a barrier material having a first side and a second side. The first encapsulation layer is formed of a first encapsulation material and is attached to the first side of the barrier layer. The second encapsulation layer is formed of a second encapsulation material and is attached to the second side of the barrier layer. The first encapsulation material is different than the second encapsulation material and the first and second encapsulation layers encapsulate the barrier layer. The first adhesion layer is formed of a first adhesion material and is attached to the first encapsulation layer. The second adhesion layer is formed of a second adhesion material and is attached to the second encapsulation layer.

The present disclosure also is directed to methods of manufacturing a film with an extrusion system. The extrusion system includes a first extruder, a second extruder, a third extruder, a feedblock, and a die. The method includes extruding a barrier material using the first extruder to generate a barrier melt stream. The method also includes feeding the barrier melt stream to the feedblock. The method further includes extruding a first encapsulation material using the second extruder to generate a first encapsulation melt stream. The method also includes feeding the first encapsulation melt stream to the feedblock. The method further includes extruding a second encapsulation material using the third extruder to generate a second encapsulation melt stream. The method also includes feeding the second encapsulation melt stream to the feedblock. The method further includes encapsulating the barrier melt stream within the first encapsulation melt stream and the second encapsulation melt stream to form a combined melt stream using the feedblock. The first encapsulation material is different than the second encapsulation material and the first encapsulation melt stream and the second encapsulation melt stream are positioned on opposite sides of the barrier melt stream. The method also includes feeding the combined melt stream through a die to form a flat sheet.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label.

FIG. 1 is a block flow diagram of an example extrusion system in accordance with the present disclosure.

FIG. 2 is a schematic cut-away/cross-sectional view of an exemplary set of extruders, a feedblock, and a die of the extrusion system illustrated in FIG. 1 in accordance with the present disclosure.

FIG. 3 is a schematic cut-away/cross-sectional top view of an encapsulation section of the feedblock illustrated in FIG. 2 in accordance with the present disclosure.

FIG. 4 is a schematic cut-away/cross-sectional side view of the encapsulation section of the feedblock illustrated in FIGS. 2 and 3 in accordance with the present disclosure.

FIG. 5 is a schematic cut-away/cross-sectional side view of a film manufactured using the extrusion system illustrated in FIGS. 1-4 in accordance with the present disclosure.

FIG. 6 is a flow diagram illustrating an exemplary method of manufacturing the films illustrated in FIG. 5 with the extrusion system illustrated in FIGS. 1-4 in accordance with the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

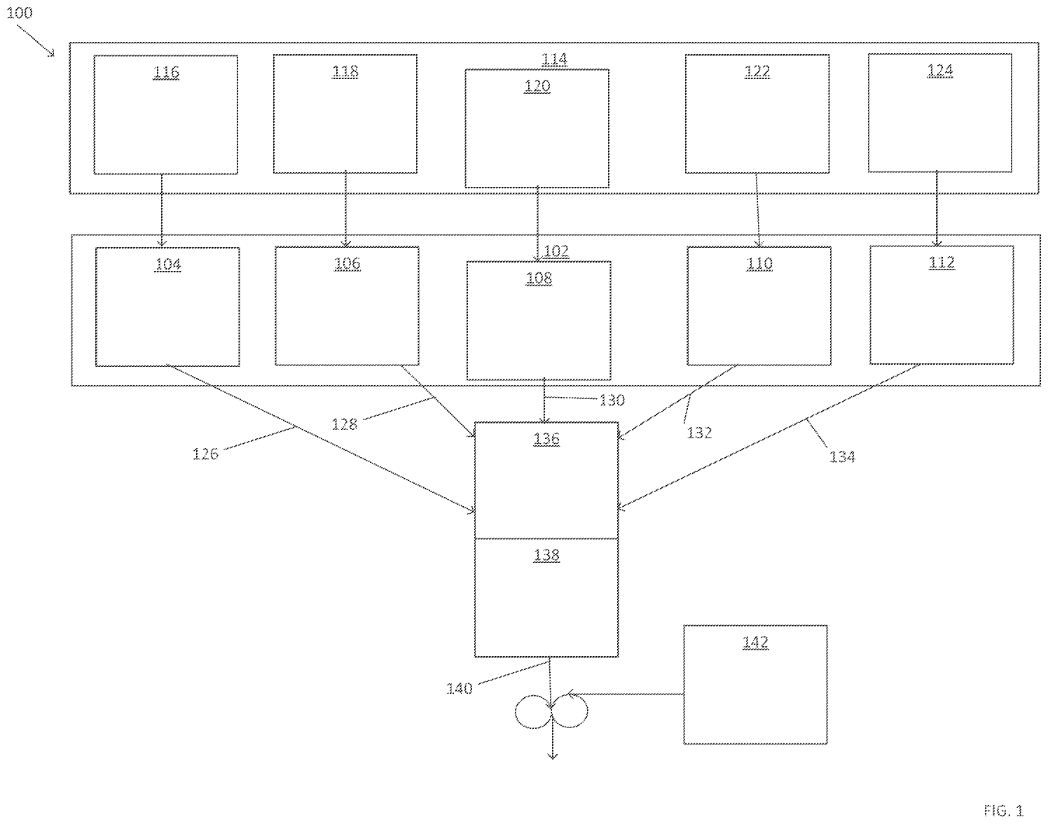

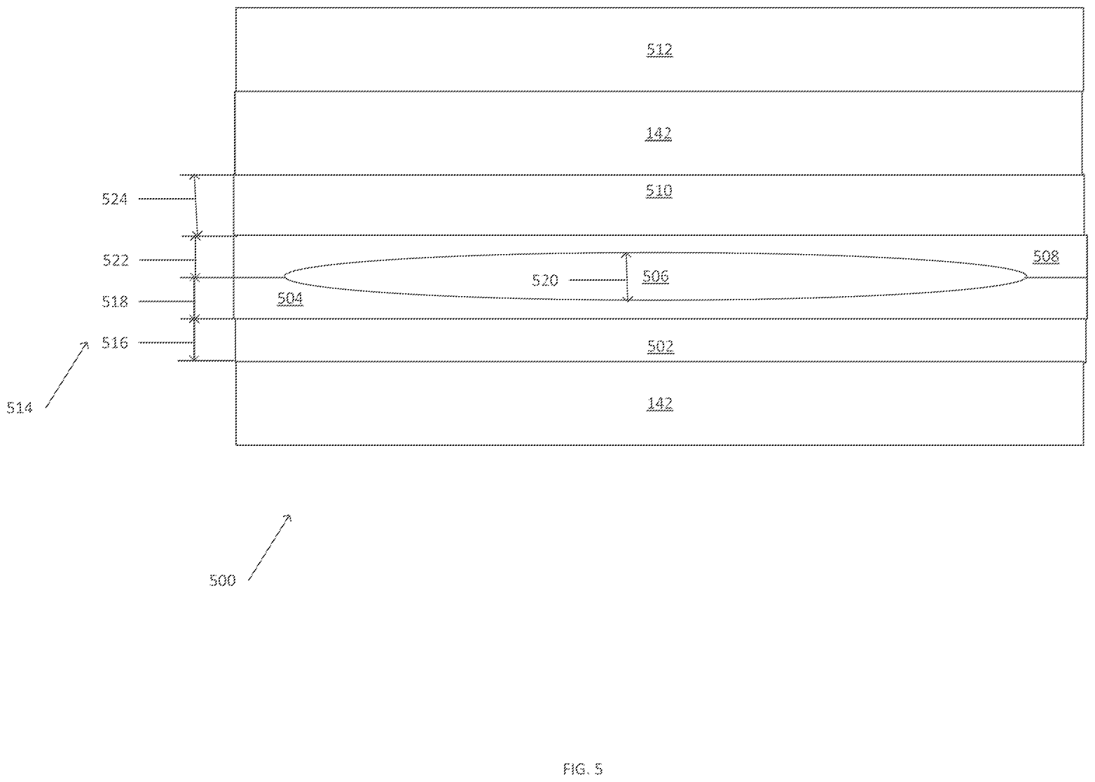

Referring now to the drawings wherein like numerals refer to like parts, FIG. 1 illustrates an extrusion system 100 for manufacturing a film 500 (shown in FIG. 5). The extrusion system 100 may include a plurality of extruders 102 that may melt and extrude a material into a melt stream. In the illustrated embodiment, the extrusion system 100 includes at least five extruders 104, 106, 108, 110, and 112. Specifically, the extrusion system 100 includes a first extruder 104, a second extruder 106, a third extruder 108, a fourth extruder 110, and a fifth extruder 112. As described herein, the third extruder 108 is configured to extrude a barrier layer 506 (shown in FIG. 5) of the film 500, the second and fourth extruders 106 and 110 are configured to extrude layers 504 and 508 that encapsulate the barrier layer 506, and the first and fifth extruders 104 and 112 are configured to extrude layers 502 and 510 that adhere to layers 504 and 508. Additionally, the film 500 may have any number of layers that enable the film 500 to operate as described herein and the extrusion system 100 may have any number of extruders 102 that enable the extrusion system 100 to manufacture the film 500 described herein.

As shown in FIG. 1, the extruders 102 are each fed one of a plurality of materials 114. In the illustrated embodiment, the materials 114 include a first material 116, a second material 118, a third material 120, a fourth material 122, and a fifth material 124. As described above, the film 500 may have any number of layers that enable the film 500 to operate as described herein and the extruders 102 may be fed any number of materials that enable the extrusion system 100 to manufacture the film 500 described herein. In the illustrated embodiment, the first material 116 will form a first layer 502 (shown in FIG. 5) of the film 500, the second material 118 will form a second layer 504 (shown in FIG. 5) of the film 500, the third material 120 will form a third layer 506 (shown in FIG. 5) of the film 500, the fourth material 122 will form a fourth layer 508 (shown in FIG. 5) of the film 500, and the fifth material 124 will form a fifth layer 510 (shown in FIG. 5) of the film 500.

The extruders 102 each generate a melt stream 126, 128, 130, 132, and 134 from the materials 114. The extruders 102 are each configured to melt the materials 114 and extrude the materials 114 into the melt streams 126-134. Specifically, in the illustrated embodiment, the first extruder 104 melts and extrudes the first material 116 to generate a first melt stream 126, the second extruder 106 melts and extrudes the second material 118 to generate a second melt stream 128, the third extruder 108 melts and extrudes the third material 120 to generate a third melt stream 130, the fourth extruder 110 melts and extrudes the fourth material 122 to generate a fourth melt stream 132, and the fifth extruder 112 melts and extrudes the fifth material 124 to generate a fifth melt stream 134. As described above, the film 500 may have any number of layers that enable the film 500 to operate as described herein and the extruders 102 may generate any number of melt streams that enable the extrusion system 100 to manufacture the film 500 described herein.

In the illustrated embodiment, the extrusion system 100 further includes at least one feedblock 136 configured to combine the melt stream 126, 128, 130, 132, and 134 in a way that results in a uniform layer distribution of the film 500. The feedblock 136 may include any feedblock technology that enables the extrusion system 100 to manufacture the film 500 described herein, including, but not limited to, vanes, laminar plates, plugs, pins, and other devices that enable the extrusion system 100 to manufacture the film 500 described herein. The melt stream 126, 128, 130, 132, and 134 are combined by the feedblock 136 and transferred for further processing.

In the illustrated embodiment, the extrusion system 100 also includes a die 138 that receives the combined melt stream 126, 128, 130, 132, and 134 to thin and spread the melt stream 126, 128, 130, 132, and 134 into a flat sheet 140. After the sheet 140 is produced, it may be laminated with one or more substrates 142 such as various substrates detailed below with reference to FIG. 5. During operations, the materials 114 are fed to the extruders 102 and the extruders 102 extrude the materials 114 into the melt stream 126, 128, 130, 132, and 134. The melt stream 126, 128, 130, 132, and 134 are then fed to the feedblock 136 and the feedblock 136 arranges the melt stream 122, 124, 126, and 128 into the uniform layer distribution of the film 500. The die 138 receives the combined melt stream 126, 128, 130, 132, and 134 from the feedblock 136 and the die 138 thins and spreads the combined melt stream 126, 128, 130, 132, and 134 into the flat sheet 140. The flat sheet 140 may then be laminated with one or more substrates 142.

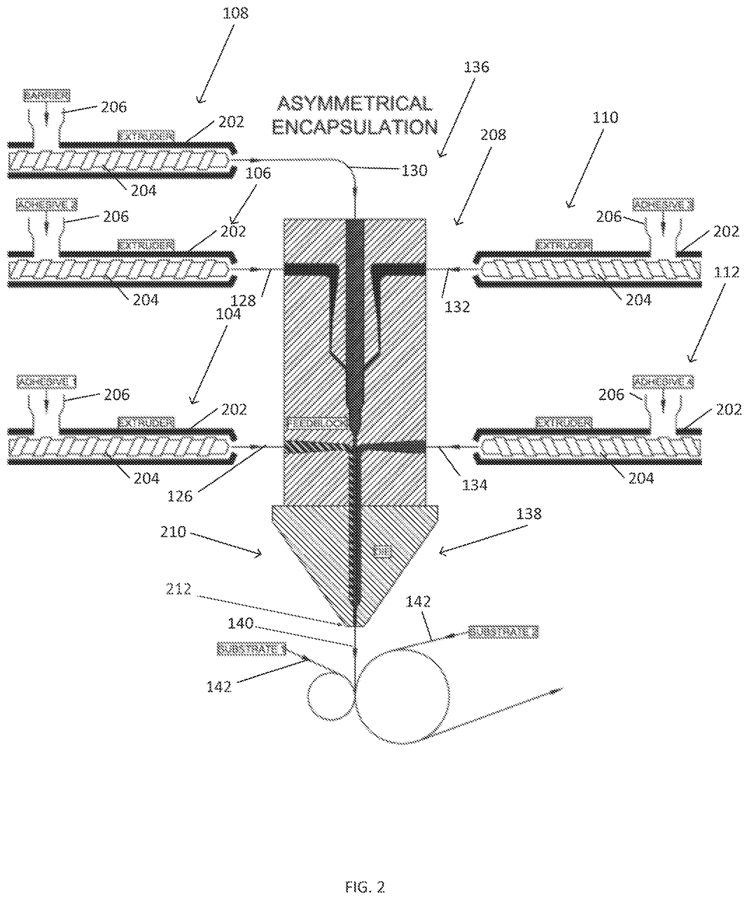

FIG. 2 is a schematic cut-away view of the extruders 102, the feedblock 136, and the die 138. As shown in FIG. 2, the extruders 102 include a single screw extruder including a barrel 202, a screw 204, and a feeder 206. The barrel 202 includes heaters (not shown) configured to melt the materials 114. During operations, the materials 114 are fed into the feeders 206 and the feeders 206 feed the materials 114 into the barrels 202. The heaters within the barrels 202 melt the materials 114 and the screws 204 propel the materials 114 through the barrel 202 and into the feedblock 136. In alternative embodiments, the extruders 102 may be any type of extruder that enables the extrusion system 100 to operate as described herein.

In the illustrated embodiment, the feedblock 136 is an encapsulating feedblock that includes an encapsulation section 208 and a feedblock section 210. The encapsulation section 208 encapsulates the third material 120 (the third layer 506) between the second and fourth materials 118 and 122 (the second and fourth layers 504 and 508), and the feedblock section 210 combines the encapsulated layers 504-508 with the first material 116 (the first layer 502) and the fifth material 124 (the fifth layer 510). The combined melt stream 126, 128, 130, 132, and 134 are sent to the die 138 to thin and spread the melt stream 126, 128, 130, 132, and 134 into the flat sheet 140. In the illustrated embodiment, the die 138 includes a metallic nozzle including an opening 212 that extrudes the sheet 140 into a predetermined shape. In the illustrated embodiment, the opening 212 is shaped to extrude the combined melt stream 126, 128, 130, 132, and 134 into the flat sheet 140. In alternative embodiments, the opening 212 may be shaped to form the sheet 140 into any shape that enables the film 500 to operate as described herein. Additionally, in alternative embodiments, the feedblock 136 and the die 138 may be any type of feedblock and die that enables the extrusion system 100 to operate as described herein.

As described below, the third layer 506 formed from the third material 120 is a barrier layer configured to prevent the migration of molecules such as, for example, oxygen and water vapor, through the film 500. The third material 120 may be a thermally sensitive material that may degrade at high temperatures. The feedblock 136 described herein encapsulates the third material 120 in materials 118 and 122 that are less thermally sensitive to enable the third material 120 to be incorporated into the film 500 without degrading the third material 120. Moreover, the feedblock 136 described herein encapsulates the third material 120 in different materials 118 and 122 such that different layers may be attached to either side of the third layer 506. Specifically, as described below, in the illustrated embodiment, the second material 118 is different than the fourth material 122, and the first material 116 is different than the fifth material 124. The second material 118 is a material that is configured to adhere to the first material 116 and the fourth material 122 is a material that is configured to adhere to the fifth material 124. Additionally, the second material 118 may not adhere to the fifth material 124 as well as the fourth material 122 and the fourth material 122 may not adhere to the first material 116 as well as the second material 118. As such, the structure of the film 500 on opposite sides of the third layer 506 is different because the feedblock 136 enables the third layer 506 to be encapsulated in two different materials 118 and 122 on either side of the third layer 506 and enables different layers to be attached to either side of the third layer 506. Thus, the feedblock 136 described herein enables the film 500 to include a barrier layer 506 encapsulated within a film structure that is different on either side of the barrier layer 506, optimizing or tuning the structure of the film 500 for different environments.

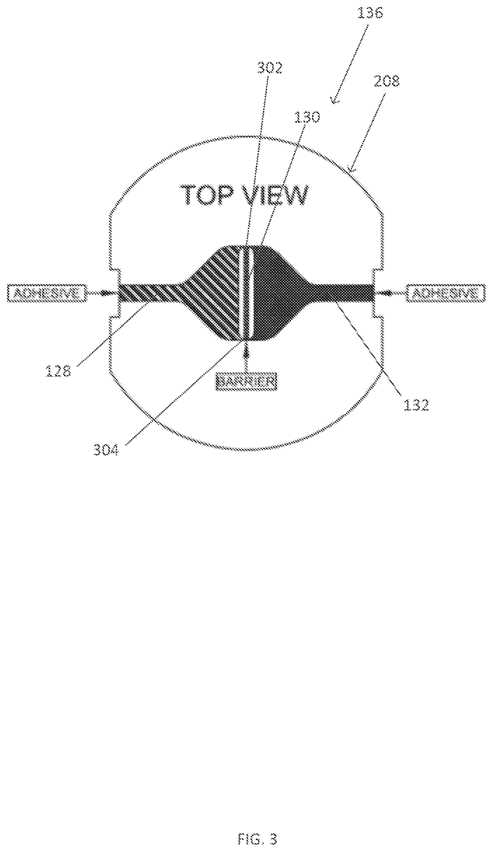

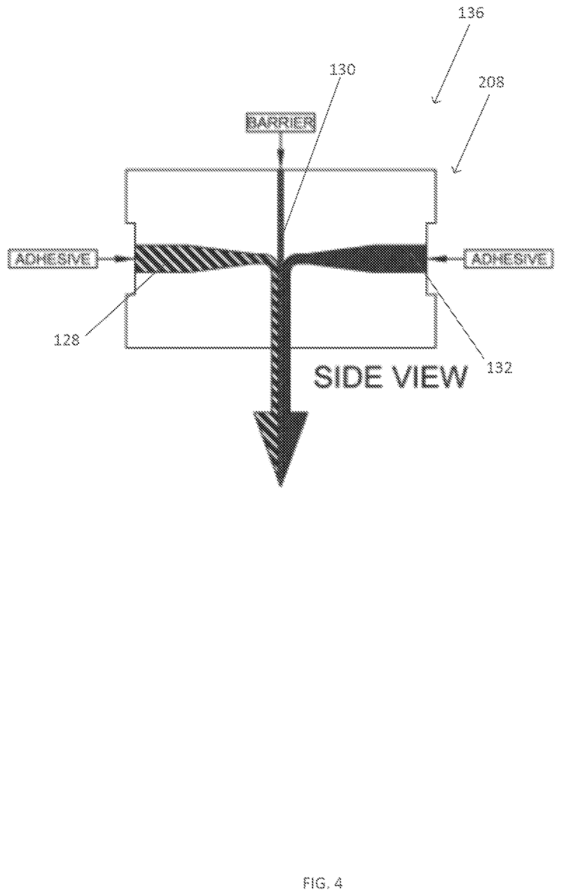

FIG. 3 is a schematic cross-sectional top view of the encapsulation section 208 of the feedblock 136 and FIG. 4 is a schematic cross-sectional side view of the encapsulation section 208 of the feedblock 136. As shown in FIGS. 2-4, the third material 120 is encapsulated in the second and fourth materials 118 and 122 by feeding the third melt stream 130 into the feedblock 136 and feeding the second melt stream 128 and the fourth melt stream 132 into the feedblock 136 on opposite sides of the third melt stream 130. As shown in FIG. 3, within the feedblock 136, the third melt stream 130 has a first edge 302 and a second edge 304. The second melt stream 128 and the fourth melt stream 132 are fed into the feedblock 136 such that the second melt stream 128 and the fourth melt stream 132 each first contact the first edge 302 and the second edge 304 of the third melt stream 130. That is, channels within the feedblock 136 are configured such that the boundaries between the second layer 504 and the fourth layer 508 are established at the first edge 302 and the second edge 304 of the third melt stream 130 before the second melt stream 128 and the fourth melt stream 132 contact the rest of the third melt stream 130. As shown in FIG. 4, the second melt stream 128 and the fourth melt stream 132 then contact the rest of the third melt stream 130 to envelop and encapsulate the third melt stream 130, forming the second to fourth layers 504-508 of the film 500 and encapsulating the barrier layer 506 within the film 500.

Referring back to FIG. 2, the encapsulated layers 504-508 are combined with the first and fifth materials 116 and 124 by feeding the encapsulated layers 504-508 into the feedblock section 210 of the feedblock 136 and feeding the first melt stream 126 and the fifth melt stream 134 into the feedblock section 210 of the feedblock 136 on opposite sides of the encapsulated layers 504-508. The first melt stream 126 and the fifth melt stream 134 are fed into the feedblock 136 on opposite sides of the encapsulated layers 504-508 such that the first melt stream 126 and the fifth melt stream 134 each attach to the second melt stream 128 and the fourth melt stream 132 respectively. Thus, the feedblock 136 forms the uniform layer distribution of the film 500 and encapsulates the barrier layer 506 within the film 500. Finally, the flat sheet 140 is laminated to substrates 142 to form the film 500. Additionally, one or more outer layers 512 may be attached to the substrates 142 to complete the film 500.

Additionally, the feedblock 136 may be configured to combine the layers 502-510 such that the layers 502-510 each have different thicknesses 514. Specifically, the thickness 514 of each of the layers 502-510 may determine bond strength and adhesion between the layers 502-510. In the illustrated embodiment, channels within the feedblock 136 and the extruders 102 may be configured to optimize or tune the thicknesses 514 of the layers 502-510 to optimize or tune the bond strength and adhesion between the layers 502-510. Accordingly, the feedblock 136 and the extruders 102 may be configured to optimize and/or tune the thicknesses 514 of the layers 502-510 to optimize or tune the film 500 for different environments and/or uses.

For example, the first layer 502 has a first layer thickness 516, the second layer 504 has a second layer thickness 518, the third layer 506 has a third layer thickness 520, the fourth layer 508 has a fourth layer thickness 522, and the fifth layer 510 has a fifth layer thickness 524. The layer thickness 514 may all be the same or they may all be different. Additionally, some layer thickness 514 may be the same and some may be different. Thus, the feedblock 136 and the extruders 102 may be configured to optimize and/or tune the thicknesses 514 of the layers 502-510 to optimize or tune the film 500 for different environments and/or uses.

FIG. 5 illustrates the improved film 500 that may be produced by the extrusion system 100 described above with reference to FIGS. 1-4. As shown in FIG. 5, the film 500 includes the first layer 502, the second layer 504, the third layer 506, the fourth layer 508, the fifth layer 510, two substrates 142, and the outer layer 512. As described above, the third layer 506 is encapsulated in the second layer 504 and fourth layer 508, the first and fifth layers 502 and 510 are combined with the encapsulated layers 504-508, the substrates 142 are laminated to the first and fifth layers 502 and 510, and the outer layer 512 is attached to the substrates 142. In the illustrated embodiment, the third layer 506 is a barrier layer, the second layer 504 and fourth layer 508 are first and second encapsulating layers, the first and fifth layers 502 and 510 are first and second adhesive layers. In alternative embodiments, the layers 502-512 and 142 may be any type of layer that enables the film 500 to operate as described herein.

The arrangement of the layers 502-512 and 142 within the film 500 is configured to enable the film 500 to be optimized or tuned for different applications. Specifically, materials are capable of creating bonds of varying strengths to other materials and the arrangement of the materials that are capable of creating strong bonds next to each other may optimize or tune the film 500 to operate in different environments. For example, in the illustrated embodiment, the third layer 506 is formed of a barrier material, the second layer 504 is formed of a first encapsulation material, the fourth layer 508 is formed of a second encapsulation material, the first layer 502 is formed of a first adhesion material, and the fifth layer 510 is formed of a second adhesion material. In the illustrated embodiment, the first encapsulation material is a different material than the second encapsulation material, the first adhesion material is a different material than the second adhesion material, and the barrier material is a different material than the first encapsulation material, the second encapsulation material, the first adhesion material, and second adhesion material. The different materials of the barrier material, the first encapsulation material, the second encapsulation material, the first adhesion material, and second adhesion material enable the film 500 to be optimized or tuned to operate in different environments.

Specifically, in the illustrated embodiment, the first encapsulation material is a different material than the second encapsulation material to enable the structure of the film 500 on either side of the third layer 506 to be optimized or tuned to operate in different environments. The first encapsulation material is a material that is configured to adhere to the first adhesion material and the second encapsulation material is a material that is configured to adhere to the second adhesion material. Additionally, the first encapsulation material may not adhere to the second adhesion material as well as the second encapsulation material and the second encapsulation material may not adhere to the first adhesion material as well as the first encapsulation material. As such, the structure of the film 500 on opposite sides of the third layer 506 is different because the feedblock 136 enables the third layer 506 to be encapsulated in two different materials on either side of the third layer 506 and enables different layers to be attached to either side of the third layer 506. Thus, the feedblock 136 described herein enables the film 500 to include the barrier layer 506 encapsulated within a film structure that is different on either side of the barrier layer 506, optimizing or tuning the structure of the film 500 for different environments.

In the illustrated embodiment, the barrier layer may be composed of any thermoplastic polymeric material that may prevent the migration of molecules such as, for example, oxygen and water vapor, thereby protecting sensitive materials contained within packages made from the film 500. For example, the film 500 may be utilized as a bag that may be sealed on all sides and may completely surround an article such as an article of food contained therein. The barrier layer may preferably be made from a material having superior barrier properties such as, for example, polymers and/or copolymers of ethylene vinyl alcohol (EVOH) and EVOH blends of nylon or polyethylene. Moreover, other materials may include polyamide polymers, copolymers and blends thereof; polyvinylidene chloride and polyvinylidene chloride/methyl acrylate copolymer; acrylonitrile polymers and copolymers; and polyethylene copolymers and/or blends. The adhesive layer may preferably be made from resins of polyethylene; polyamide polymers, copolymers and blends thereof; acrylonitrile polymers and copolymers; and polyethylene copolymers and/or blends.

The barrier layer may be a thermally sensitive material that is protected by the first and second encapsulation layers and the first and second adhesion layers. The first and second encapsulation layers may be coextruded to encapsulate the barrier layer such that the barrier layer is completely surrounded by the first and second encapsulation layers. The encapsulated barrier layer and first and second encapsulation layers may then be coextruded with and/or encapsulated by the first and second adhesion layers at a higher temperature than the encapsulated barrier layer and first and second encapsulation layers. The first and second encapsulation layers and the first and second adhesion layers may protect the barrier layer from the high temperatures necessary to adequately melt and extrude the first and second encapsulation layers and the first and second adhesion layers or any other layer coextruded, laminated or otherwise disposed adjacent to the barrier layer.

In the illustrated embodiment, the first and second encapsulation layers may preferably be made from an acid terpolymer of, preferably, ethylene, acrylic acid and methyl acrylate to encapsulate the barrier layer made from EVOH and to attach the barrier layer to adhesive layers, substrates, and/or outer layers of the film structure while protecting the EVOH barrier layer from high temperatures and long residence times within the coextrusion hardware. Moreover, acid terpolymer may be used as an encapsulation layer for the following barrier layers: EVOH; EVOH/nylon blends; EVOH/polyethylene (“PE”) copolymers; polyamides and acrylonitrile.

Further, polyamide, otherwise known as nylon, also may adequately bond EVOH barrier layers to adhesive layers, substrates, and/or outer layers. Polyamide adhesive layers may adhere to the following barrier layers at relatively low melt temperatures: EVOH, EVOH/nylon blends, EVOH/PE copolymers and polyamide. Moreover, acid terpolymers and nylon may provide good adhesion to EVOH without causing the optical clarity problems associated with maleic anhydride.

In the illustrated embodiment, the first adhesion material may be acrylic polymers, copolymers, and terpolymers; anhydride modified polymers, copolymer, and terpolymers; vinyl acetate modified polymer; and/or any other material. Additionally, in the illustrated embodiment, the second adhesion material may be acrylic polymers, copolymers, and terpolymers; anhydride modified polymers, copolymer, and terpolymers; vinyl acetate modified polymer and/or any other material. Finally, in the illustrated embodiment, the first adhesion material is any material that is configured to bond to the first encapsulation material, and the second adhesion material is any material that is configured to bond to the second encapsulation material.

The substrates 142 may include any substrate necessary to modify or tune the physical properties of the film 500. For example, the substrates 142 may include any material that may add strength, stiffness, heat resistance, abuse resistance, durability and/or printability to the film 500. Further, the substrates 142 may act to prevent the migration of certain types of molecules, such as, for example, moisture, from penetrating into the film 500. Further, the substrates 142 may add flex crack resistance to the film 500. In addition, the substrates 142 may be composed of a material that may act as a sealant when heated. However, it should be noted that the substrates 142 may be composed of any material that enables the film 500 to operate as described herein.

The outer layers 512 may include any substrate necessary to modify or tune the physical properties of the film 500. For example, the outer layers 512 may include any material that may add strength, stiffness, heat resistance, abuse resistance, durability and/or printability to the film 500. Further, the outer layers 512 may act to prevent the migration of certain types of molecules, such as, for example, moisture, from penetrating into the film 500. Further, the outer layers 512 may add flex crack resistance to the film 500. In addition, the outer layers 512 may be composed of a material that may act as a sealant when heated. However, it should be noted that the outer layers 512 may be composed of any material that enables the film 500 to operate as described herein.

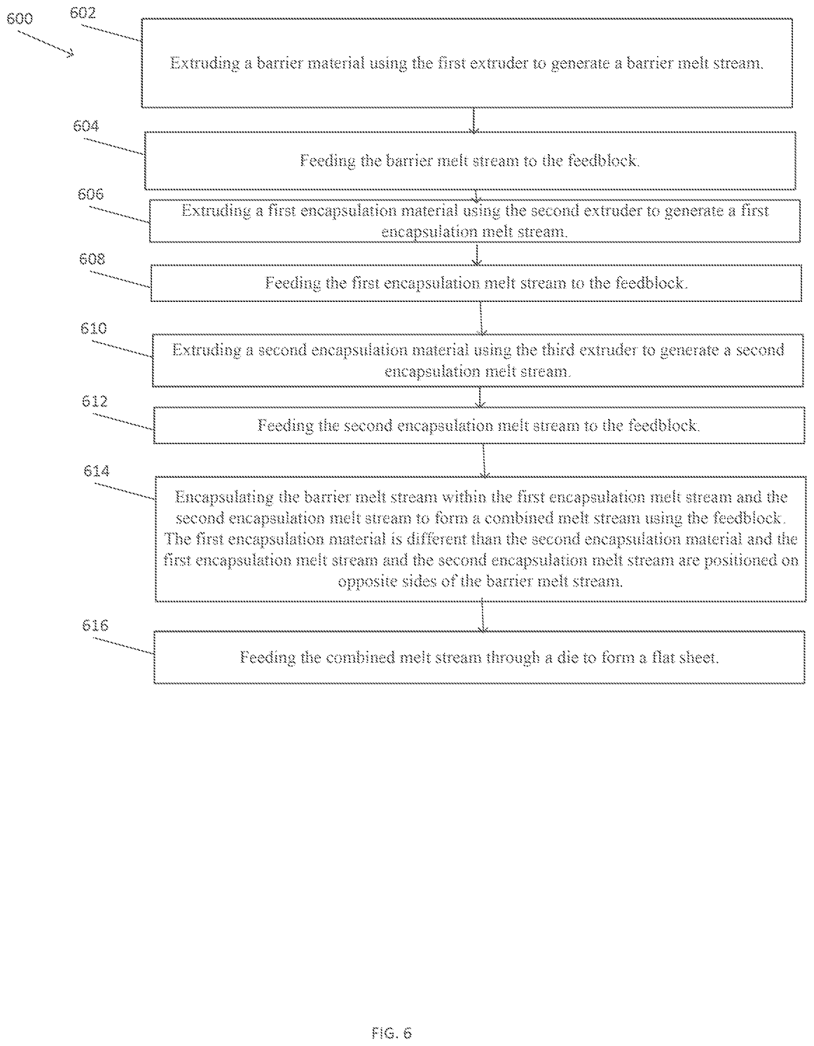

FIG. 6 is a flow diagram illustrating an example method 600 of manufacturing a film with an extrusion system. The extrusion system includes a first extruder, a second extruder, a third extruder, a feedblock, and a die. The method 600 includes extruding 602 a barrier material using the first extruder to generate a barrier melt stream. The method 600 also includes feeding 604 the barrier melt stream to the feedblock. The method 600 further includes extruding 606 a first encapsulation material using the second extruder to generate a first encapsulation melt stream. The method 600 also includes feeding 608 the first encapsulation melt stream to the feedblock. The method 600 further includes extruding 610 a second encapsulation material using the third extruder to generate a second encapsulation melt stream. The method 600 also includes feeding 612 the second encapsulation melt stream to the feedblock. The method 600 further includes encapsulating 614 the barrier melt stream within the first encapsulation melt stream and the second encapsulation melt stream to form a combined melt stream using the feedblock. The first encapsulation material is different than the second encapsulation material and the first encapsulation melt stream and the second encapsulation melt stream are positioned on opposite sides of the barrier melt stream. The method 600 also include feeding 616 the combined melt stream through a die to form a flat sheet.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A film structure comprising:
a barrier layer formed of a barrier material having a first side and a second side;
a first encapsulation layer formed of a first encapsulation material and attached to the first side of the barrier layer; and
a second encapsulation layer formed of a second encapsulation material and attached to the second side of the barrier layer, wherein the first encapsulation material is different than the second encapsulation material and the first and second encapsulation layers encapsulate the barrier layer.

2. The film structure of claim 1, wherein the barrier material is different than the first encapsulation material and the second encapsulation material.

3. The film structure of claim 1, wherein the first encapsulation layer has a first encapsulation layer thickness and the second encapsulation layer has a second encapsulation layer thickness different than the first encapsulation layer thickness.

4. The film structure of claim 3, wherein the barrier layer has a barrier layer thickness different than the first encapsulation layer thickness and the second encapsulation layer thickness.

5. The film structure of claim 1, wherein the first encapsulation layer has a first encapsulation layer thickness and the second encapsulation layer has a second encapsulation layer thickness equal to the first encapsulation layer thickness.

6. The film structure of claim 1, wherein the barrier layer is formed of ethylene vinyl alcohol (EVOH).

7. The film structure of claim 1, wherein the barrier layer is formed of Polyvinylidene dichloride (PVDC).

8. A film structure comprising:
a barrier layer formed of a barrier material having a first side and a second side;
a first encapsulation layer formed of a first encapsulation material and attached to the first side of the barrier layer;
a second encapsulation layer formed of a second encapsulation material and attached to the second side of the barrier layer, wherein the first encapsulation material is different than the second encapsulation material and the first and second encapsulation layers encapsulate the barrier layer;
a first adhesion layer formed of a first adhesion material and attached to the first encapsulation layer; and
a second adhesion layer formed of a second adhesion material and attached to the second encapsulation layer.

9. The film structure of claim 8, wherein the barrier material is different than the first encapsulation material and the second encapsulation material.

10. The film structure of claim 8, wherein the first adhesion material is different than the second adhesion material.

11. The film structure of claim 8, wherein the barrier material is different than the first adhesion material and the second adhesion material.

12. The film structure of claim 8, wherein the first encapsulation material, the second encapsulation material, the first adhesion material, and the second adhesion material are all different materials.

13. The film structure of claim 8, further comprising a first substrate laminated to at least one of the first adhesion layer and the second adhesion layer.

14. The film structure of claim 13, further comprising a second substrate laminated to at least one of the first adhesion layer and the second adhesion layer.

15. The film structure of claim 14, further comprising an outer layer attached to at least one of the first substrate and the second substrate.

16. The film structure of claim 8, wherein the first encapsulation material is configured to adhere to the first adhesion material.

17. The film structure of claim 8, wherein the second encapsulation material is configured to adhere to the second adhesion material.

18. The film structure of claim 8, wherein the first encapsulation material is configured to form a stronger bond to the first adhesion material than the second adhesion material.

19. The film structure of claim 8, wherein the second encapsulation material is configured to form a stronger bond to the second adhesion material than the first adhesion material.

20. A method of manufacturing a film structure with an extrusion system, the extrusion system including a first extruder, a second extruder, a third extruder, a feedblock, and a die, the method comprising:
extruding a barrier material using the first extruder to generate a barrier melt stream;
feeding the barrier melt stream to the feedblock;
extruding a first encapsulation material using the second extruder to generate a first encapsulation melt stream;
feeding the first encapsulation melt stream to the feedblock;
extruding a second encapsulation material using the third extruder to generate a second encapsulation melt stream;
feeding the second encapsulation melt stream to the feedblock;
encapsulating the barrier melt stream within the first encapsulation melt stream and the second encapsulation melt stream to form a combined melt stream using the feedblock, wherein the first encapsulation material is different than the second encapsulation material and the first encapsulation melt stream and the second encapsulation melt stream are positioned on opposite sides of the barrier melt stream; and
feeding the combined melt stream through a die to form a flat sheet.
